(19) United States
(12) Patent Application Publication
(10) Pub. No.: US 2010/0213809 A1
(43) Pub. Date: Aug. 26, 2010

(54) HEADLAMP AND ITS USE

(75) Inventors: Manfred Roehl, Bruckmuehl (DE); Bernhard Siessegger, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/678,800

(22) PCT Filed: Aug. 12, 2008
(86) PCT No.: PCT/EP2008/060558

§ 371 Date: Mar. 18, 2010

(30) Foreign Application Priority Data
Sep. 19, 2007 (DE) 10 2007 044 628.6
Dec. 11, 2007 (DE) 10 2007 059 471.4

(51) Int. Cl. H01J 61/52; F21K 99/00; H01K 1/30; H01J 5/00

(52) U.S. Cl. 313/46; 313/358; 313/110; 313/317

(57) ABSTRACT

A headlamp is provided having a cap and a light output which is predetermined by international standardization with respect to the distance and position with respect to a reference plane of the cap, wherein the light output is provided by one or more semiconductor light sources.

### TECHNICAL FIELD

The invention relates to the field of headlamps, and in particular it relates to a headlamp having a cap and a light output which is predetermined by international standardization with respect to the distance and position with respect to a reference plane of the cap.

### PRIOR ART

ECE Standard No. 98 “UNIFORM PROVISIONS CONCERNING THE APPROVAL OF MOTOR VEHICLE HEADLAMPS EQUIPPED WITH GAS-DISCHARGE LIGHT SOURCES” describes various gas discharge lamps, which are used in the motor-vehicle industry, with respect to the position of the discharge arc with respect to a defined reference plane. Every discharge lamp which is intended to be used as a headlamp in a motor vehicle must comply with this Standard.

ECE Standard No. 37 “Uniform provisions concerning the approval of filament lamps for use in approved lamp units on power-driven vehicles and of their trailers” describes various incandescent lamps which are used in the motor-vehicle industry, with respect to the position of their incandescent filaments with respect to a defined reference plane. Every headlamp having an incandescent filament and which is intended to be used in a motor vehicle must comply with this Standard.

DE 10 2005 026 949 A1 discloses a light-emitting diode lamp as a light source for a headlight. The design of this lamp is in this case matched to the headlight structure which is designed for use of the light-emitting diode lamp.

### OBJECT

The object of the invention is to specify a lamp which is provided with semiconductor light sources and can be used as a headlamp in headlights which are designed for installation of incandescent lamps or gas discharge lamps.

### DESCRIPTION OF THE INVENTION

The object is achieved by a headlamp having a cap and a light output which is predetermined by international standardization with respect to the distance and position with respect to a reference plane of the cap, in which the light output is provided by one or more semiconductor light sources.

Operating electronics or a part of the operating electronics for operation of the one or more semiconductor light sources are or is in this case advantageously arranged in the cap of the headlamp. The lamp can therefore be used directly without any further measures instead of a gas discharge lamp or incandescent lamp provided for this application.

If the one or more semiconductor light sources is or are arranged on a supporting structure having a first flat face and a second flat face parallel thereto, this has the advantage that the required light emission characteristic can be complied with very easily. In this case, in each case at least one semiconductor light source should be located on the first flat face, and at least one semiconductor light source should be located on the second flat face, coincident with respect to one another. In order to comply with the diameter defined in the Standard for the incandescent filament described there or the discharge arc described there, in the area of the semiconductor light sources which are located one above the other coincidentally, the supporting structure preferably has a web between the first and the second flat faces, which web has a thickness of such a size that the light-emitting surfaces of the semiconductor light sources are at a distance from one another which corresponds to the average diameter, as stipulated in the Standard, of the incandescent filament described there and/or of the discharge arc described there.

In order to achieve more uniform light emission, it may be advantageous to arrange in each case one or more semiconductor light sources on both flat faces of the supporting structure, wherein in each case at least one semiconductor light source is positioned on the first flat face, and at least one semiconductor light source is positioned on the second flat face, alternately, or at least partially coincidentally opposite.

The supporting structure is preferably at the same time in the form of a heat sink and is composed of a highly thermally conductive material. This measure means that the semiconductor light sources are cooled as well as possible. In one advantageous development, the supporting structure includes at least one first part and one second part, the first part of the supporting structure is at the same time in the form of a heat sink, and the second part of the supporting structure is in the form of a support for the semiconductor light sources and is composed of a highly thermally conductive material. This has the advantage that the second part of the supporting structure may be in the form of a printed circuit board, and can therefore be prefabricated at low cost and efficiently. In one advantageous development, the supporting structure includes more than two parts, wherein some of the parts are composed of an electrically conductive material and are at the same time in the form of power supply lines. Those parts of the supporting structure which are isolated from one another and act as heat sinks are therefore themselves used as a power supply line, and there is no need to apply conductors thereto.

If the second part, which is in the form of a printed circuit board, partially or completely has the operating electronics, further costs can be saved by the standardized production.

The supporting structure preferably tapers toward the tip of the lamp and/or it has a cooling structure which protrudes sideways. The structure therefore assumes the form of a conventional lamp, which has advantages for installation and arrangement in a headlight reflector. In addition, the supporting structure may also have a heat-emitting and/or antireflective coating, in order to improve the optical and thermal characteristics of the lamp.

If the operating electronics (75) are thermally connected to a first heat sink (341), which is in the form of a first part of the cap housing, they can be cooled better. If the supporting structure (3) is then thermally connected to a second heat sink (342), which is in the form of a second part of the cap housing, it can be cooled independently of the operating electronics, particularly if the first heat sink (341) and the second heat sink (342) are thermally isolated from one another. The light-emitting diodes and the operating electronics are therefore thermally decoupled from one another, thus ensuring more efficient cooling.

If the semiconductor light sources have optics which vary a light emission characteristic of the semiconductor light sources such that this corresponds to an emission characteristic as required in the Standard, the requirement relating to the placing of the semiconductor light sources is less stringent, and this has advantages for the fitting and the production of the semiconductor light sources. In this case, the semiconductor light sources are preferably light-emitting diodes. Particularly preferably, the semiconductor light sources are multichip light-emitting diodes. However, the semiconductor light sources may also be organic light-emitting diodes. It is advantageous for the semiconductor light sources to be coated in this case with a protective layer in order to protect them reasonably during the use and during the severe operating time in a motor vehicle. For this purpose, the supporting structure, together with the semiconductor light sources, may, however, also advantageously be surrounded by a protective bulb. The material of the protective bulb is in this case preferably a light-transmissive plastic or a glass. In this case, the protective bulb is filled with a gas, for optical and thermal reasons.

The headlamp in this case preferably has operating electronics (100) for operation of semiconductor light sources (21) on an operating device for gas discharge lamps. In this case, the operating electronics (100) simulate the burning voltage of an incandescent lamp or gas discharge lamp. When the headlamp is used as a replacement for a gas discharge lamp, it preferably simulates the burning voltage during cold starting and the burning voltage during steady-state operation of a gas discharge lamp. If the operating electronics can be switched to simulate a gas discharge lamp containing mercury and a gas discharge lamp which has no mercury, this considerably extends the field of application of the headlamp. The headlamp can therefore be used directly as a retrofit lamp without having to make any changes to the headlight or to the motor vehicle.

In this case, in the case of a headlamp as a replacement for a gas discharge lamp, the operating electronics preferably include a rectifier (103) as well as a voltage intermediate circuit (104) with a dissipative voltage limiting device.

### BRIEF DESCRIPTION OF THE DRAWING(S)

The invention will be explained in more detail in the following text with reference to exemplary embodiments. In the figures:

FIG. 1 shows a side view of a first embodiment of a headlamp according to the invention.

FIG. 2 shows a schematic plan view of the first embodiment of a headlamp according to the invention.

FIG. 3 shows a side view of a second embodiment of a headlamp according to the invention.

FIG. 4 shows a schematic plan view of the second embodiment of a headlamp according to the invention.

FIG. 5 shows a side view of a third embodiment of a headlamp according to the invention.

FIG. 6 shows a side view of a fourth embodiment of a headlamp according to the invention, with a light function.

FIG. 7 shows a side view of the fourth embodiment of a headlamp according to the invention with two light functions.

FIG. 8 shows a side view of the fourth embodiment of a headlamp according to the invention with an additional cooling substructure 34.

FIG. 9 shows a side view of a fifth embodiment of a headlamp according to the invention.

FIG. 10 shows a schematic plan view of the fifth embodiment of a headlamp according to the invention.

FIG. 11 shows a side view of a sixth embodiment of a headlamp according to the invention.

FIG. 12 shows a side view of a seventh embodiment of a headlamp according to the invention.

FIG. 13 shows a side view of an eighth embodiment of a headlamp according to the invention, having an additional cooling substructure 34.

FIG. 14 shows a schematic section through a ninth embodiment having two heat sinks, which are thermally isolated from one another, in the cap, one of which is associated with the electronics and another is associated with the semiconductor light sources.

FIG. 15a shows a schematic section through the eighth embodiment, in a variant with beads in order to increase the robustness and the cooling areas.

FIG. 15b shows a schematic section through the eighth embodiment in a variant with an increased material thickness in order to increase the robustness and cooling areas.

FIG. 16a shows a section through a second part of the structure 3, in an integral variant.

FIG. 16b shows a section through a second part of the structure 3 in a two-part variant.

FIG. 16c shows a section through a second part of the structure 3 in a two-part variant with cutouts.

FIG. 17 shows a schematic block diagram of operating electronics according to the invention.

FIG. 18 shows a circuit diagram of a first voltage intermediate circuit, in which it is possible to switch between the burning voltage of a gas discharge lamp without any mercury and the burning voltage of a gas discharge lamp which contains mercury.

FIG. 19 shows a circuit diagram of a second switchable voltage intermediate circuit, which simulates the start-up of a gas discharge lamp.

FIG. 20 shows a variant of the second switchable voltage intermediate circuit, which simulates the start-up of a gas discharge lamp and can be switched between the burning voltage of a gas discharge lamp without any mercury and the burning voltage of a gas discharge lamp which contains mercury.

### PREFERRED EMBODIMENTS OF THE INVENTION

The headlamp according to the invention is preferably in the form of a so-called retrofit lamp for a conventional headlamp. It is therefore intended to allow the keepers of motor vehicles with conventional lamp technology, and in particular the keepers of classic vehicles, to use the most modern semiconductor lighting technology.

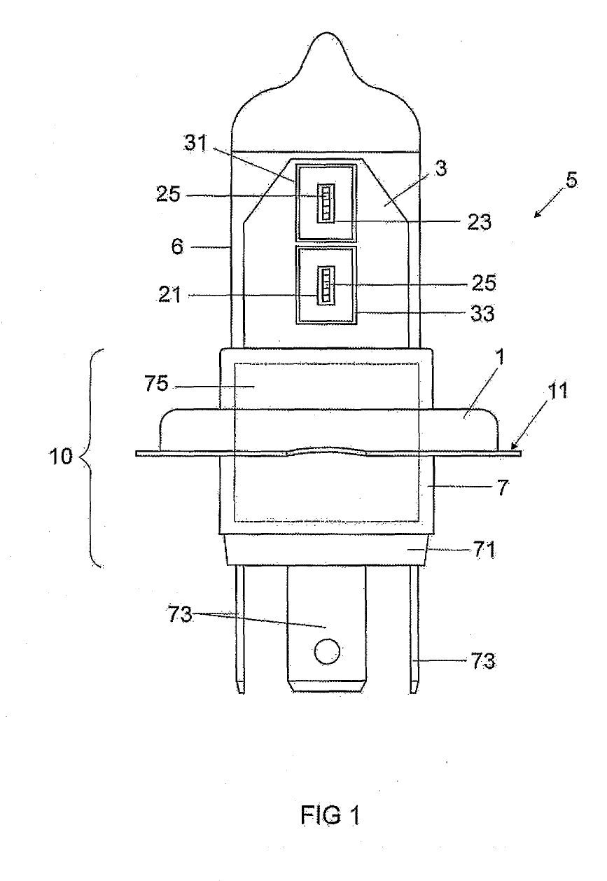

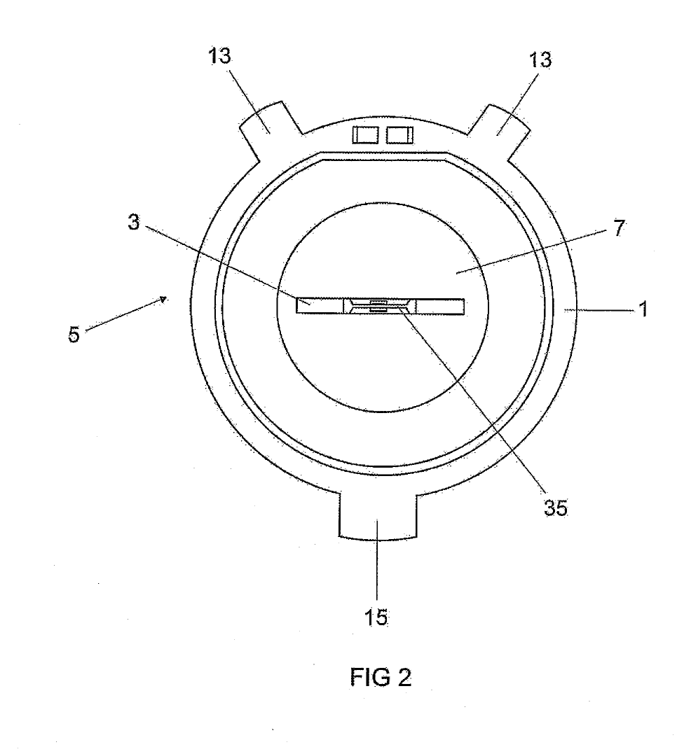

FIG. 1 shows a side view of a first embodiment as an H4 retrofit lamp. Some of the details described in the following text can be seen only in the schematic plan view in FIG. 2. The lamp 5 is formed on a conventional lamp cap 10 which has a reference ring 1 which is fitted to a cap sleeve 7. The reference ring 1 includes a ring which has reference lugs 13, on three sides, which in turn describe a reference plane 11, by means of slightly curved contact points. The cap sleeve 7 includes a cylindrical hollow body which is terminated at its lower end by a cap block 71. Three contact tabs 73 are embedded in this cap block 71, which is composed of an insulating material, such as plastic or ceramic. Operating electronics 75 are accommodated in the cavity located above the cap block 71 in the cap sleeve 7. A supporting structure 3 is fitted to the upper face of the cap sleeve 7, and semiconductor light sources are arranged on its surface. At the same time, the supporting structure 3 is used as a heat sink for the semiconductor light sources, and is therefore composed of a highly thermally conductive material such as aluminum, copper, an alloy containing iron or a thermally conductive metal-ceramic composite, for example, an LTCC ceramic. The semiconductor light sources are preferably in the form of light-emitting diodes. It is also feasible for the semiconductor light sources to be in the form of organic light-emitting diodes. The light-emitting diodes are preferably in the form of multichip light-emitting diodes 21, 23, which have a plurality of light-emitting diode chips 25, for example in a row. A structure such as this is also known as a light-emitting diode array. The operating electronics 75 are connected to the multichip light-emitting diodes 21, 23 via conductor tracks (not illustrated) which are arranged on or in the supporting structure 3. In order to supply voltage, the operating electronics 75 are connected to the contact tabs 73 (not illustrated).

In order to have comparable optical characteristics to a conventional H4 lamp, the geometry of the lighting area of the multichip light-emitting diodes 21, 23 is designed analogously to the geometric area projection of the corresponding incandescent filament. This means that the length of the light-emitting area of the multichip light-emitting diodes 21, 23 is equal to the length of the corresponding incandescent filament, and that the width of the light-emitting area of the multichip light-emitting diodes 21, 23 is equal to the diameter of the corresponding incandescent filament.

Since the dipped-light incandescent filament of an H4 lamp radiates only in a half-space, a multichip light-emitting diode 23 is fitted on only one face of the supporting structure 3. However, instead of a multichip light-emitting diode 23, it is also possible to use a plurality of light-emitting diodes with one chip or a plurality of multichip light-emitting diodes 23 with a small number of chips for each light-emitting diode. In order to make it possible to comply with the optical requirements, the supporting structure has a recess 31 at the point at which the dipped-light incandescent filament is located in a conventional incandescent lamp. The multichip light-emitting diode 23 is fitted in this recess 31. The depth of the recess 31 is designed such that the distance from the optical axis to the light-emitting area of the multichip light-emitting diode 23 corresponds essentially to the radius of the corresponding incandescent filament. Alternatively, the depth of the recess 31 can be of such a size that the light-emitting area of the multichip light-emitting diode 23 lies on the optical axis. In order to match the emission characteristic of the multichip light-emitting diode 23 to the emission characteristic of the incandescent filament, the multichip light-emitting diode 23 may have optics (not shown here). The recess 31 has inclined edges, in order to impede the light output from the multichip light-emitting diode 23 as little as possible.

Since the main-beam incandescent filament of an H4 lamp radiates in both half-spaces, the supporting structure 3 has two opposite recesses 33 (only one of which can be seen in FIG. 1). The opposite recesses 33 are coincident and have the same profile. One multichip light-emitting diode 21 is fitted in each of the two recesses 33, and its light-emitting areas therefore radiate in opposite directions. Each multichip light-emitting diode 21 therefore radiates into one half-space. The depth of the recesses 33 is designed such that the web 35 which remains in the supporting structure has a thickness which is of such a size that the distance between the light-emitting areas of the multichip light-emitting diodes 21 corresponds essentially to the diameter of the incandescent filament.

The supporting structure 3 is connected to the cap sleeve by means of suitable processes, for example welding, soldering, clamping or adhesive bonding. In order to save weight and material, the supporting structure 3 can preferably taper toward the tip of the lamp.

For protection against environmental influences, the multichip light-emitting diodes 21, 23 may be provided with a protective layer. In order to give the users of the retrofit lamp the same sensation as an incandescent lamp, the entire supporting structure 3 can also be incorporated in a light-transmissive protective bulb 6 composed of glass or plastic, which protects the entire structure against environmental influences. In order to improve the cooling of the light-emitting diodes, the bulb 6 is then preferably provided with a filling gas such as nitrogen. The filling gas is preferably at a pressure of more than 5*10⁴ Pa. If the filling gas is at a higher pressure than atmospheric pressure, then the bulb 6 is preferably designed to be resistant to fracture.

For optical adjustment during manufacture, the cap sleeve 7 can be rotated, tilted or moved linearly with respect to the reference ring 1, as in the case of a conventional H4 lamp. The proven production and adjustment methods for conventional lamps can therefore be transferred. When the cap sleeve 7 together with the supporting structure 3 and the multichip light-emitting diodes 21, 23 arranged thereon is adjusted with respect to the reference ring, the connection is made between the reference ring 1 and the cap sleeve 7. The lamp is then optically adjusted thereby.

### Second Embodiment

The second embodiment differs from the first embodiment only in the number of functions which can be carried out by the headlamp. Only the differences from the first embodiment will therefore be described.

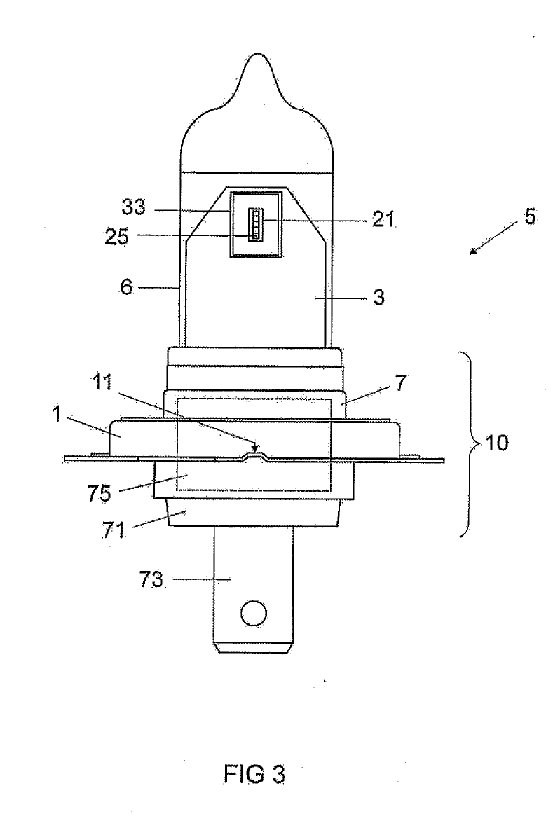

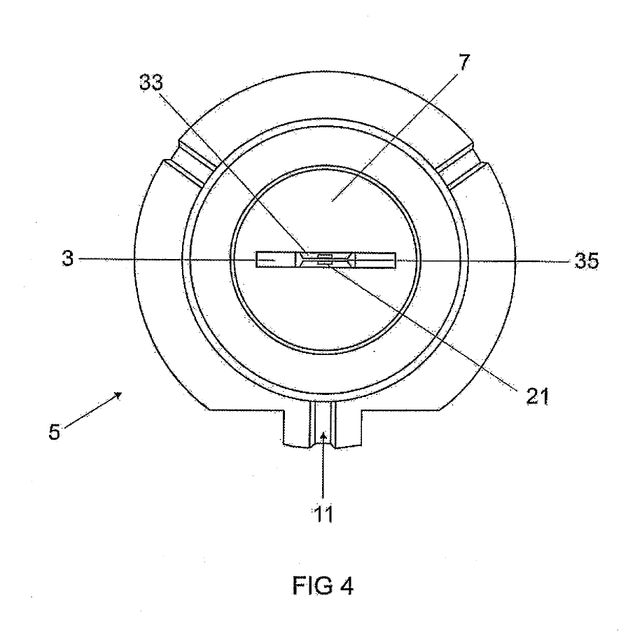

FIG. 3 illustrates a side view of the second embodiment of the headlamp 5. As in the case of the first embodiment, some of the details can be seen only in the schematic plan view in FIG. 4.

The difference from the first embodiment is that the second embodiment is in the form of a retrofit lamp for a conventional headlamp with only one incandescent filament. This is illustrated in FIGS. 3 and 4, using the example of an H7 lamp.

An H7 lamp is equipped with a freely radiating incandescent filament which radiates into both half-spaces. The headlamp according to the invention is therefore equipped with at least two multichip light-emitting diodes 21, which each radiate in opposite spatial directions. As in the case of the first exemplary embodiment, the multichip light-emitting diodes 21 are mounted in two recesses 33 in the supporting structure 3. In this case, the recesses 33 may also have inclined edges. The light-emitting area of the multichip light-emitting diodes 21 once again corresponds to the length and the diameter of an H7 incandescent filament. The web 35 which remains in the supporting structure between the two recesses 33 has a thickness which is designed such that the distance between the light-emitting areas of the multichip light-emitting diodes corresponds essentially to the diameter of an H7 incandescent filament. The operating electronics 75 are once again accommodated in the cap sleeve 7. Since only one light function is provided here, only two contact tabs 73 are mounted in the cap block 71.

### Third Embodiment

The third embodiment differs from the previous embodiments in the design of the supporting structure 3. The differences from the previous embodiments will be described in the following text.

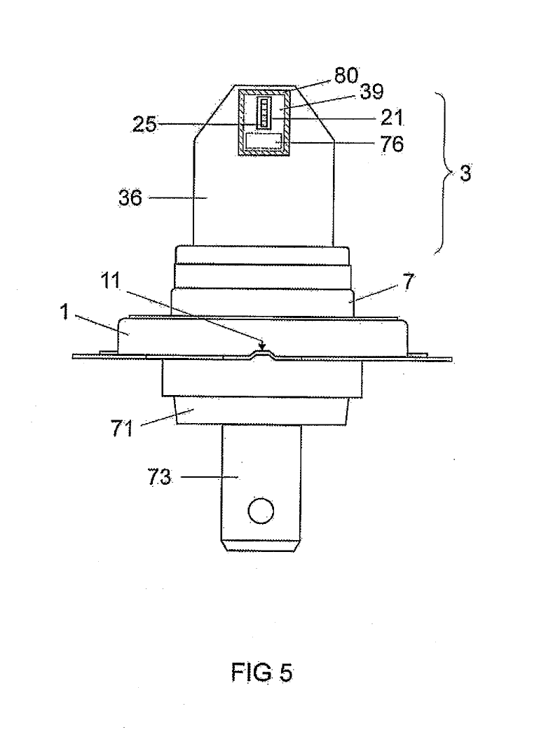

In the third embodiment, which is illustrated in FIG. 5, the supporting structure is formed from two parts. The first part 36 of the supporting structure 3 is connected to the cap sleeve 7. The first part 36 of the supporting structure 3 is provided with conductor tracks which are arranged on or in the part (not shown) and is composed of a highly thermally conductive material such as copper, aluminum, steel or nickel-plated steel. However, it may also be composed of a highly thermally conductive single-layer or multi-layer metal-ceramic composite. This has the advantage that the conductor structures which are required can be introduced into the composite body while it is actually being produced. The second part 39 of the supporting structure 3 is electrically and thermally connected to the first part 36 of the supporting structure 3. The electrical connection relates to the conductor tracks which run on or in the first part 36 of the supporting structure 3. If the first part 36 of the supporting structure 3 is composed of a conductive material, then that part itself can, of course, also carry a potential. The conductor tracks in the first part and/or the first part itself are/is connected to the contact tabs 73. The second part 39 of the supporting structure 3 is used mainly as a circuit mount, and contains the multichip light-emitting diodes 21. In addition, the operating electronics 76 or a part of the operating electronics can also be arranged on the second part 39 of the supporting structure 3, with the rest of the operating electronics then being located in the cap sleeve 7. Depending on the light function to be provided, the second part 39 is fitted on one side or on both sides with in each case at least one multichip light-emitting diode 21. Alternatively, the second part can also be fitted with in each case at least one single-chip light-emitting diode.

The embodiment shown in FIG. 5 once again relates to an H7 headlamp with one light function. However, this embodiment may, of course, also be designed to have two light functions. For this purpose, either a further functional unit of the second part 39 of the supporting structure 3 must be provided, or the one part 39 of the supporting structure 3 must be designed to be correspondingly large, in order to allow both light functions to be accommodated.

Since the second part 39 of the supporting structure 3 is used as a circuit mount, but the heat which is created by the light-emitting diodes is also at the same time intended to be emitted to the first part 36 of the supporting structure 3, a circuit mount technique is preferably used here which conducts heat well. By way of example, this may be a board composed of an LTCC ceramic or a ceramic-metal composite (for example DCB® from the Curamik Company). This has the advantage that some parts such as resistors or capacitors in the operating electronics 76 can also be embedded in the ceramic, and the operating electronics 76 can thus be produced efficiently and in a space-saving manner. However, it is also possible to use other technologies, such as a metal-core board with a thin polyimide or polyester film as the conductor-track mount. In order to allow the heat to be passed efficiently from the second part 39 of the supporting structure 3 to the first part 36 of the supporting structure 3, a good thermal connection is provided between the parts, with a large contact area 80. This ensures the required good thermal link between the light-emitting diodes and the first part 36, which is used as a heat sink, of the supporting structure 3.

In order to improve the mechanical robustness, the first part 36 of the supporting structure 3 may have mechanical robustness features such as beads, reinforced areas or struts. In order to improve the thermal and optical characteristics, the first part 36 and the second part 39 of the supporting structure 3 preferably have a heat-emitting and antireflective coating.

### Fourth Embodiment

The fourth embodiment differs from the third embodiment mainly in that the supporting structure 3 includes more than two parts. Otherwise, the statements made above apply analogously here.

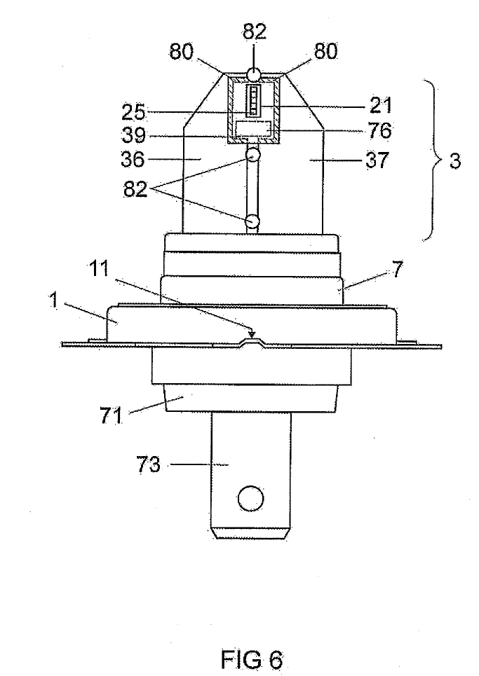

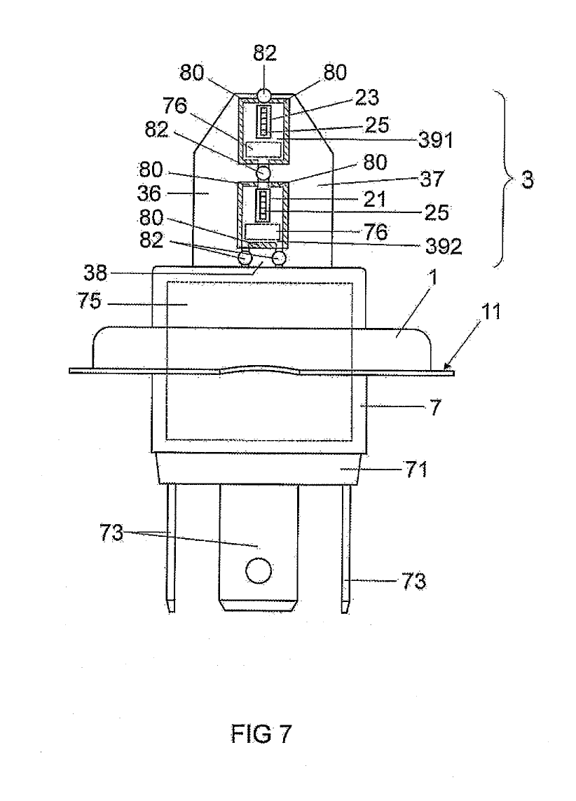

A lamp according to the fourth embodiment and having one light function (such as an H7 lamp) is illustrated in FIG. 6. A lamp according to the fourth embodiment having two light functions (such as an H4 lamp) is illustrated in FIG. 7. In this embodiment, the supporting structure 3 is subdivided into a plurality of functional parts, some of which are composed of a conductive material such as copper, aluminum, steel or some other suitable material.

A first variant with one light function is illustrated in FIG. 6. The supporting structure 3 includes a first part 36, a second part 39 and a third part 37. The first part and the third part are both produced from an electrically conductive material. The two parts 36, 37 are therefore used not only as a supporting structure and heat sink but at the same time also as a power supply line for the second part 39 of the supporting structure 3 and for the light-emitting diodes located on it. This has the major advantage that there is no need for supply conductor tracks, and the electrical link between the operating electronics and the light-emitting diodes can be very simple and robust. In this embodiment as well, a good thermal link is required between the second part 39 of the supporting structure 3 on the first part 36, and the third part 37 of the supporting structure 3. A connection to a large contact area 80 is provided for this purpose.

In order to provide mechanical robustness for the first part 36 and third part 37 of the supporting structure 3, which are isolated from one another, adhesive points 82 are provided between the two parts. The adhesive points are composed of a suitable adhesive, which mechanically holds the parts firmly together and keeps them electrically galvanically isolated.

Analogously to the first variant, FIG. 7 shows a second variant of the fourth embodiment. This forms a lamp with two light functions, that is otherwise designed analogously to the first variant. In order to allow two light functions to be provided, the second part 39, which contains the light-emitting diodes, of the supporting structure 3 is subdivided into two functional units 391 and 392. The first functional unit 391 contains at least one light-emitting diode or one multichip light-emitting diode 23, which is fitted on one face. The second functional unit 392 is fitted on two sides and contains at least one light-emitting diode or one multichip light-emitting diode 23 on each face. Both functional units may each have operating electronics 76.

In order to supply electricity to the second functional unit 392, a fourth part 38 of the supporting structure 3 is provided, and is arranged centrally between the first part 36 of the supporting structure 3 and the third part 37 of the supporting structure 3. In order to make the supporting structure mechanically robust, adhesive points 82 are once again arranged here between the first part 36, the third part 37 and the fourth part 38 of the supporting structure 3. These make the structure robust, but electrically isolate the parts from one another.

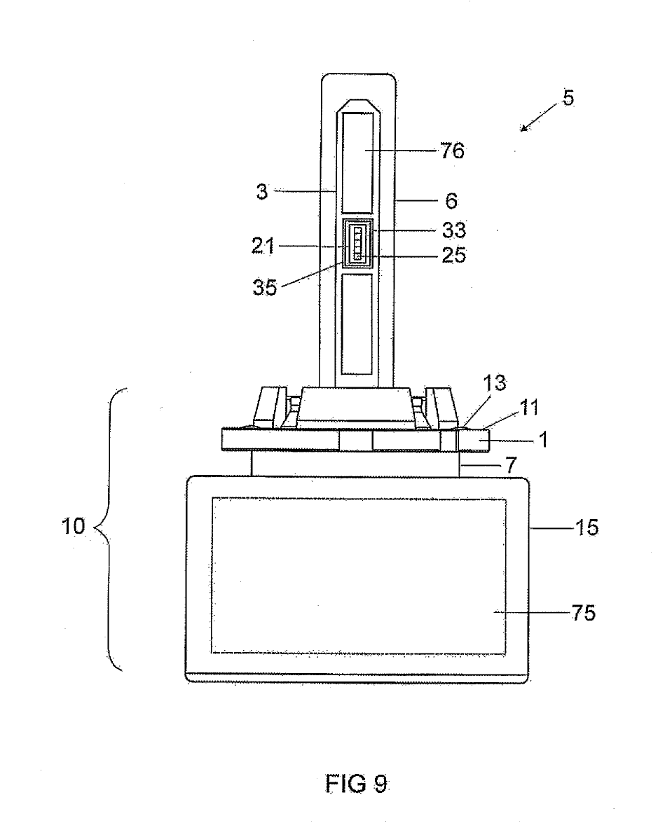

In order to achieve further mechanical robustness, the first part and the third part 36, 37 of the supporting structure 3 can be provided with beads, thickened material areas or the like. FIG. 9a shows a section through a fourth embodiment which is provided with beads. The first part and the third part 36, 37 of the supporting structure 3 are each provided with one bead. This measure considerably improves the resistance to oscillation in the vertical and horizontal directions of the lamp, and also increases the cooling area and mass.

A similar result can be achieved by deliberate material reinforcements, as is indicated in FIG. 9b. This measure achieves an increase in the oscillation resistance as well as the cooling mass, cross section and surface area. Various other variants can also be used to increase the surface area and to provide robustness, such as rib systems and various profilings.

Both FIGS. 9a and 9b show optics 22 on the multichip light-emitting diodes 21. These are used to match the emission characteristic of the planar light areas of the multichip light-emitting diodes 21 to the emission characteristic of the conventional headlamp with incandescent filaments.

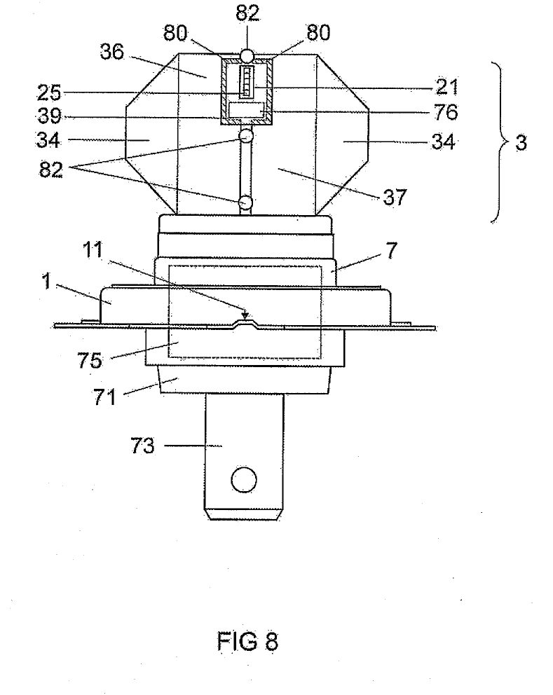

In order to further enlarge the cooling area, the first and third parts 36, 37 of the supporting structure 3 can also go beyond the “boundary” of the cap sleeve 7, as is illustrated in a third variant of the fourth embodiment in FIG. 8. In this case, the first and third parts 36, 37 of the supporting structure 3 each also have additional cooling structures 34. These structures can be ribbed, provided with beads or formed in some other suitable manner in order to enlarge the surface area and for stiffening. The rest of the design is analogous to that of the first and second variants.

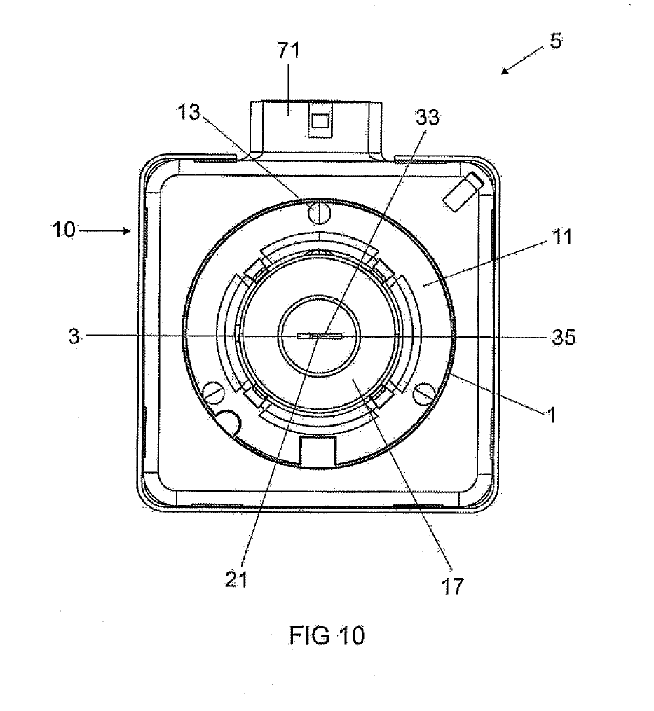

FIG. 9 illustrates a side view of a fifth embodiment as a retrofit lamp for a D1 or D3 gas discharge lamp. Some of the details described in the following text can be seen in the schematic plan view in FIG. 10. The lamp 5 is constructed on a conventional D-lamp cap 10, which has a reference ring 1 which is fitted to a cap sleeve 7. The reference ring 1 includes a ring which has reference studs 13 on three faces, which studs describe a reference plane 11. The cap sleeve 7 is cast on the reference ring 1 and a square cap housing 15. A connecting socket 71 projects out of the cap housing 15 and is composed of an insulating material, such as plastic or ceramic. Three contacts 73 (not shown) are embedded in the connecting socket 71. Operating electronics 75 are accommodated in the cap housing 15. An inner cap 17 is introduced to the cap sleeve 7 and a supporting structure 3 is fitted to its upper face, on the surface of which structure 3 semiconductor light sources are arranged. At the same time, the supporting structure 3 is used as a heat sink for the semiconductor light sources, and is therefore composed of a highly thermally conductive material such as aluminum, copper, an alloy containing iron or a thermally conductive metal-ceramic composite, for example an LTCC ceramic. The semiconductor light sources are preferably in the form of light-emitting diodes. It is also feasible for the semiconductor light sources to be in the form of organic light-emitting diodes. The light-emitting diodes are preferably in the form of multichip light-emitting diodes 21 which have a plurality of light-emitting diode chips 25, for example in a row. A structure such as this is therefore also known as a light-emitting diode array. The operating electronics 75 are connected to the multichip light-emitting diodes 21 via conductor tracks (not illustrated) which are arranged on or in the supporting structure 3. The operating electronics 75 are connected to the contacts 73 for supplying voltage (not illustrated).

In order to have comparable optical characteristics to a conventional D-lamp, the geometry of the lighting area of the multichip light-emitting diodes 21 is designed analogously to the geometric area projection of the corresponding discharge arc. This means that the length of the light-emitting area of the multichip light-emitting diodes 21 is equal to the length of the corresponding arc, and the width of the light-emitting area of the multichip light-emitting diodes 21 is equal to the mean diameter of the corresponding discharge arc.

Since the discharge arc of a D-lamp radiates in both half-spaces, the supporting structure 3 has two opposite recesses 33 (only one of which can be seen in FIG. 9). The opposite recesses 33 are designed to be coincident and to have the same profiles. A multichip light-emitting diode 21 is fitted in each of the two recesses 33, and their light-emitting areas therefore radiate in opposite directions. Each multichip light-emitting diode 21 therefore radiates into one half-space. However, it is also possible to use a plurality of light-emitting diodes with one chip or a plurality of multichip light-emitting diodes 21 with fewer chips per light-emitting diode, instead of one multichip light-emitting diode 21. The depth of the recesses 33 is designed such that the web 35 which remains in the supporting structure has a thickness which is of such a size that the distance between the light-emitting areas of the multichip light-emitting diodes 21 corresponds essentially to the mean diameter of the discharge arc.

The supporting structure 3 is connected to the cap 10 by means of suitable processes, for example welding, soldering, clamping or adhesive bonding. In order to save weight and material, the supporting structure 3 can preferably taper toward the tip of the lamp.

For protection against environmental influences, the multichip light-emitting diodes 21 may be provided with a protective layer. In order to give the users of the retrofit lamp the same sensation as a discharge lamp, the entire supporting structure 3 can also be introduced into a light-transmissive protective bulb 6 composed of glass or plastic, which furthermore protects the entire structure against environmental influences. For better cooling of the light-emitting diodes, the bulb 6 is then preferably provided with a filling gas such as nitrogen. The filling gas is preferably at a pressure of more than 5*10⁴ Pa. If the filling gas is at a higher pressure than atmospheric pressure, then the bulb 6 is preferably designed to be resistant to fracture.

For optical adjustment during manufacture, the inner cap 17 can be rotated, tilted or moved linearly with respect to the cap 10, in the same way as in a conventional D-lamp. This makes it possible to adopt the proven production and adjustment methods for D-lamps. When the inner cap 17 together with the supporting structure 3 and the multichip light-emitting diodes 21 arranged thereon is adjusted with respect to the cap 10, the connection is made between the cap 10 and the inner cap 17. The lamp is therefore then adjusted optically.

### Sixth Embodiment

The sixth embodiment differs in the design of the supporting structure 3 from the fifth embodiment. Only the differences therefrom will be described in the following text.

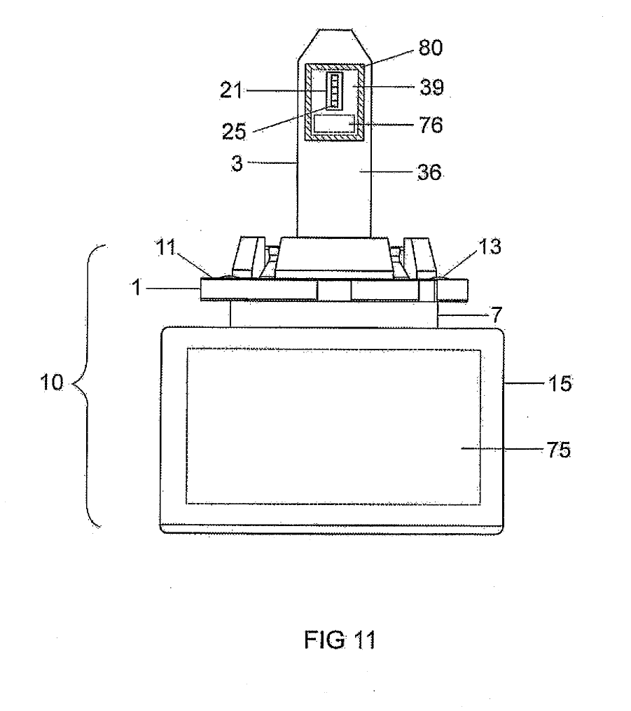

In the sixth embodiment, which is illustrated in FIG. 11, the supporting structure is formed from two parts. The first part 36 of the supporting structure 3 is connected to the cap sleeve 7. The first part 36 of the supporting structure 3 is provided with conductor tracks, which are arranged on or in the part (not shown), and is composed of a highly thermally conductive material such as copper, aluminum, steel or nickel-plated steel. However, it may also be composed of a highly thermally conductive single-layer or multi-layer metal-ceramic composite. This has the advantage that conductor structures which are required can actually be incorporated therein during the production of the composite body. The second part 39 of the supporting structure 3 is electrically and thermally connected to the first part 36 of the supporting structure 3. The electrical connection relates to the conductor tracks which run on or in the first part 36 of the supporting structure 3. If the first part 36 of the supporting structure 3 is composed of a conductive material, then the part itself can, of course, also carry a potential. The conductor tracks on the first part and/or the first part itself are/is connected to the operating electronics 75. The second part 39 of the supporting structure 3 is used mainly as a circuit mount, and contains the multichip light-emitting diodes 21. In addition, the operating electronics 76 or a part of the operating electronics can also be arranged on the second part 39 of the supporting structure 3, with the rest of the operating electronics then being located in the cap housing 15. The second part 39 is fitted with in each case at least one multichip light-emitting diode 21 on both sides. Alternatively, the second part can also be fitted with in each case at least one single-chip light-emitting diode.

Since the second part 39 of the supporting structure 3 is used as a circuit mount, but the heat which is created by the light-emitting diodes is also at the same time intended to be emitted to the first part 36 of the supporting structure 3, a circuit mount technique is preferably used here which conducts heat well. By way of example, this may be a board composed of an LTCC ceramic or a ceramic-metal composite (for example DCB® from the Curamik Company). This has the advantage that some parts such as resistors or capacitors in the operating electronics 76 can also be embedded in the ceramic, and the operating electronics 76 can thus be produced efficiently and in a space-saving manner. However, it is also possible to use other technologies, such as a metal-core board with a thin polyimide or polyester film as the conductor-track mount. In order to allow the heat to be passed efficiently from the second part 39 of the supporting structure 3 to the first part 36 of the supporting structure 3, a good thermal connection is provided between the parts, with a large contact area 80. This ensures the required good thermal link between the light-emitting diodes and the first part 36, which is used as a heat sink, of the supporting structure 3.

In order to improve the mechanical robustness, the first part 36 of the supporting structure 3 may have mechanical robustness features such as beads, reinforced areas or struts. In order to improve the thermal and optical characteristics, the first part 36 and the second part 39 of the supporting structure 3 preferably have a heat-emitting and antireflective coating.

### Seventh Embodiment

The seventh embodiment differs from the sixth embodiment mainly in that the supporting structure 3 includes more than two parts. Otherwise, the statements made above apply analogously here.

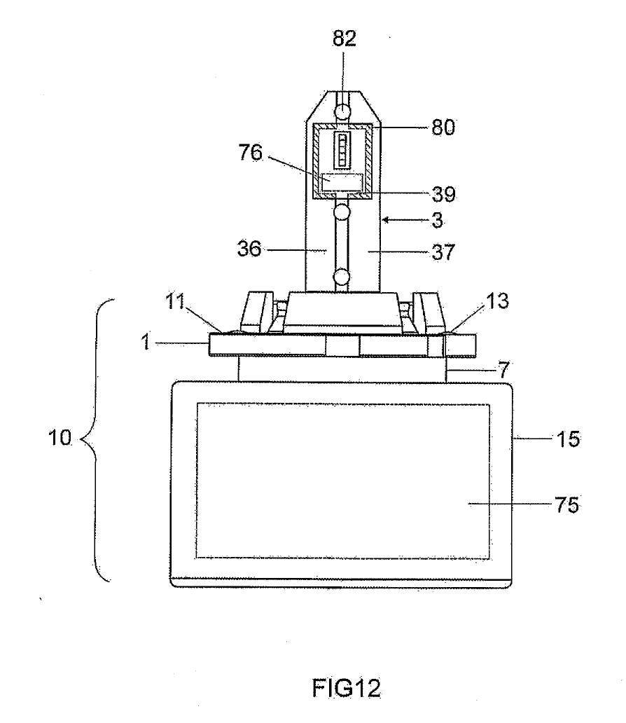

A lamp according to the seventh embodiment is illustrated in FIG. 12. In this embodiment, the supporting structure 3 is subdivided into a plurality of functional parts, some of which are composed of a thermally and electrically conductive material such as copper, aluminum, steel or some other suitable material. The supporting structure 3 includes a first part 36, a second part 39 and a third part 37. The first part and the third part are both produced from an electrically conductive material. The two parts 36, 37 are therefore used not only as a supporting structure and heat sink but at the same time also as a power supply line for the second part 39 of the supporting structure 3 and the light-emitting diodes which are located thereon. This has the major advantage that there is no need for the supply conductor tracks, and the electrical link between the operating electronics and the light-emitting diodes can be made very simple and robust. In this embodiment as well, a good thermal link is required between the second part 39 and the supporting structure 3 on the first part 36, and the third part of the supporting structure 3. A connection to a large contact area 80 is provided for this purpose.

In order to make the mutually isolated first part (36) and third part (37) of the supporting structure 3 mechanically robust, adhesive points 82 are provided between the two parts. The adhesive points are composed of a suitable adhesive which mechanically joins the parts together firmly, and keeps them electrically galvanically isolated.

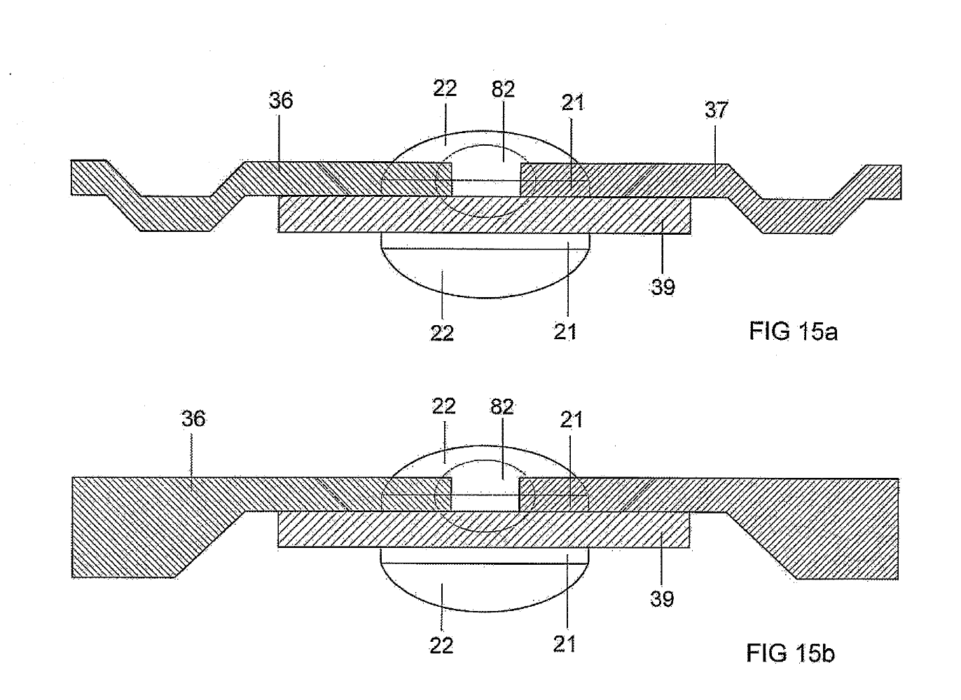

In order to achieve further mechanical robustness, the first part and the third part 36, 37 of the supporting structure 3 can be provided with beads, thickened material areas or the like. FIG. 15a shows a section through an eighth embodiment which is provided with beads. The first part and the third part 36, 37 of the supporting structure 3 are each provided with one bead. This measure considerably improves the resistance to oscillation in the vertical and horizontal directions of the lamp, and also increases the cooling area and mass.

A similar result can be achieved by deliberate material reinforcements, as is indicated in FIG. 15b. This measure achieves an increase in the oscillation resistance as well as the cooling mass, cross section and surface area. Various other variants can also be used to increase the surface area and to provide robustness, such as rib systems and various profilings.

Both FIGS. 15a and 15b show optics 22 on the multichip light-emitting diodes 21. These are used to match the emission characteristic of the planar light areas of the multichip light-emitting diodes 21 to the emission characteristic of the conventional gas discharging lamps.

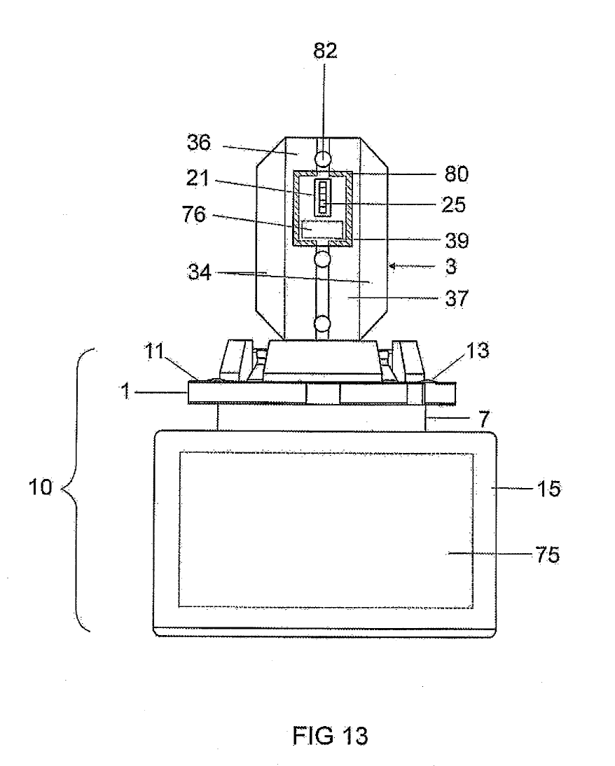

In order to further enlarge the cooling area, the first and third parts 36, 37 of the supporting structure 3 can also go beyond the “boundary” of the cap sleeve 7, as is illustrated in a third variant of the eighth embodiment in FIG. 13. In this case, the first and third parts 36, 37 of the supporting structure 3 each also have additional cooling structures 34. These structures can be ribbed, provided with beads or formed in some other suitable manner in order to enlarge the surface area and for stiffening. The rest of the design is analogous to that of the first and second variants.

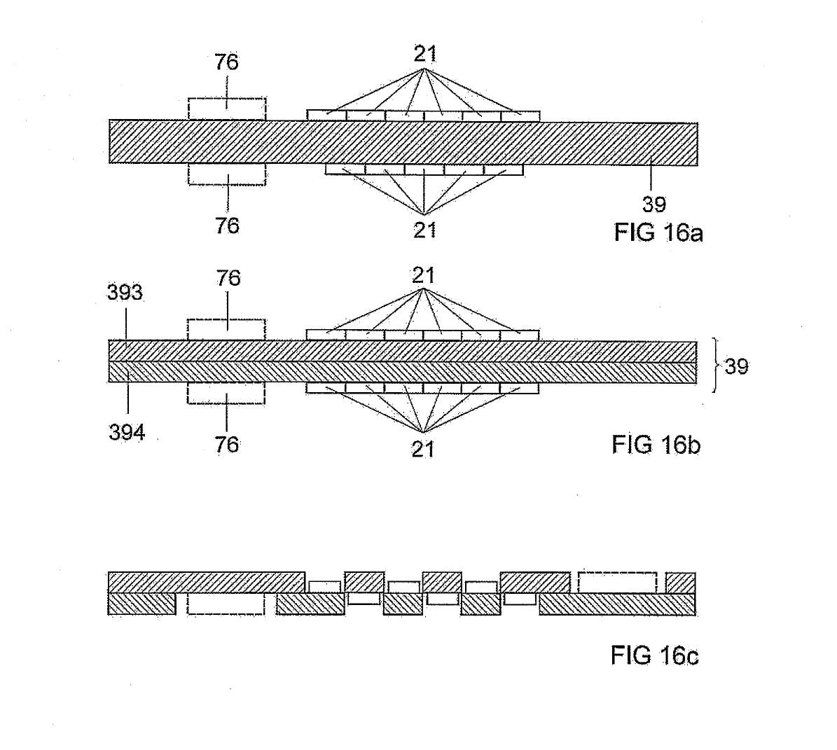

FIG. 16 shows various embodiment variants of the second part 39 of the supporting structure 3. In the first variant, shown in FIG. 16a, the second part 39 of the supporting structure 3 is formed from one piece and is fitted on both sides. In this case, the offset arrangement of the multichip light-emitting diodes 21 on the upper face and lower face can be seen particularly well, providing a better simulation of the ends of the incandescent filament or of the discharge arc. By way of example, a metal core board, a traditional board composed of GFC plastic or a ceramic structure of LTCC structure can be used as the material. It is important that the material has good thermal conductivity, in order to allow the heat which is created by the multichip light-emitting diodes to be passed on further to the other substructures of the supporting structure 3.

In order to simplify the fitting process, the second part 39 of the supporting structure 3 may also include two joined-together faces 393 and 394, as is shown in FIG. 16b. This has the advantage that the first face 393 and the second face 394 need be fitted on only one side, and they are joined together by suitable processes only after they have been fitted and tested.

In order to allow gas discharge lamps to be replaced by retrofit lamps with thicker semiconductor light sources, it is possible to use an arrangement as in FIG. 16c. This likewise includes two faces which are joined together after being fitted. However, the light-emitting areas of the multichip light-emitting diodes do not face the outer surface of the two joined-together faces 393 and 394 but the inner surface, in which case they are passed through appropriate apertures in the other face and can provide illumination onto the other face, because of the apertures. This offers the advantage that the distance between the light-emitting areas on the two faces corresponds to only approximately twice the thickness of the multichip light-emitting diodes 21.

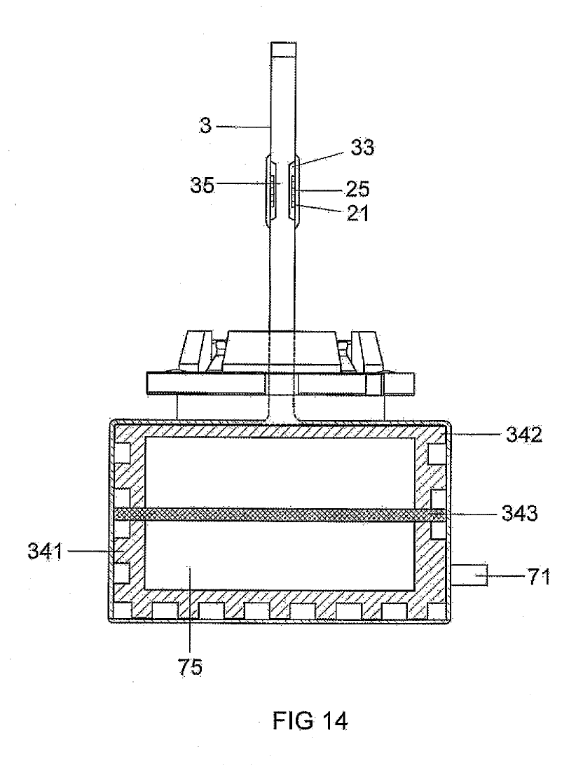

FIG. 14 shows a schematic section through a ninth embodiment with two heat sinks 341, 342, which are thermally isolated from one another, in the cap, one of which is associated with the operating electronics 75 and the other with the multichip light-emitting diodes 21. This embodiment is based on the knowledge that the operating electronics 75 and the multichip light-emitting diodes 21 cause different temperature levels and disadvantageously influence one another when a single common heat sink is used. For this reason, in the fifth embodiment, the operating electronics 75 have their own first heat sink 341, which is in the form of a part of the cap housing. The other part of the cap housing is likewise in the form of a second heat sink 342, and is thermally connected to the supporting structure 3. The two cap halves 341, 342 which are in the form of heat sinks are thermally isolated from one another by means of an isolating layer (343). The operating electronics 75 and the multichip light-emitting diodes 21 can therefore each be operated at their own temperature level, without thermally influencing one another.

### Operating Electronics

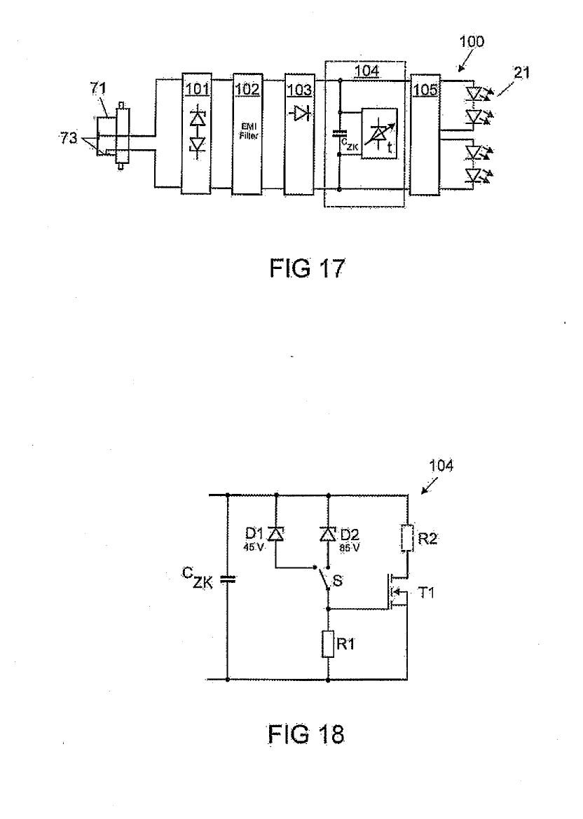

FIG. 17 shows a schematic block diagram of operating electronics 100 according to the invention, as required for one of the embodiments five to nine. The electronics obtain their power via the contacts 73 in the connecting socket 71. The connecting socket 71 is designed in a corresponding manner to the cap of a D2 or D4 gas discharge lamp. In order to protect the electronics against high-voltage pulses in the original operating device for the gas discharge lamp, a dissipative overvoltage protection 101 is provided. The overvoltage protection is followed by an EMC filter 102, in order to make it possible to comply with the appropriate motor-vehicle standards. Since the originally provided gas discharge lamp is operated with alternating current, a full-wave rectifier 103 is provided. The full-wave rectifier is followed by a voltage intermediate circuit 104 with a dissipative unidirectional voltage-limiting device. By way of example, the voltage limiting can make use of a zener diode, a varistor or a transistor T1 in parallel with an intermediate circuit capacitor C_{ZK}. The transistor T1 can be operated in the linear mode or in the switching mode. A resistor R2 is preferably connected in series with the transistor T1. The voltage in the intermediate circuit is limited to the lamp rated voltage. Regulation is provided such that a constant intermediate circuit voltage is set. There are two options, which will be described later, for the design of the voltage intermediate circuit 104.

The voltage intermediate circuit 104 is followed by a step-down DC/DC voltage converter 105. The DC/DC voltage converter 105 is, in particular, an inductor step-down converter, which operates as an electrical power source. The DC/DC voltage converter 105 has regulation which stabilizes the light-emitting diode current. The light-emitting diode current is reduced when the temperature of the light-emitting diodes is high (so-called derating switching). If there is a good thermal link, the temperature sensor which is used for overtemperature protection can also be used in the ballast electronics or, conversely, the sensor which is used for derating can be used to protect the electronics.

FIG. 18 shows a first embodiment of the voltage intermediate circuit 104. The voltage intermediate circuit 104 has the transistor T1 which has already been mentioned above and stabilizes the intermediate circuit voltage at a constant value. For this purpose, it is operated by a switchable arrangement having two zener diodes D1 and D2. The changeover switch S switches between the two diodes in such a way that the intermediate circuit voltage can be switched selectively to the burning voltage of a gas discharge lamp which has no mercury and a gas discharge lamp which contains mercury. This measure simulates the circuit of one of these two lamp types. The changeover switch may be in the form of a small DIP or pressure switch on the lower face of the lamp cap.

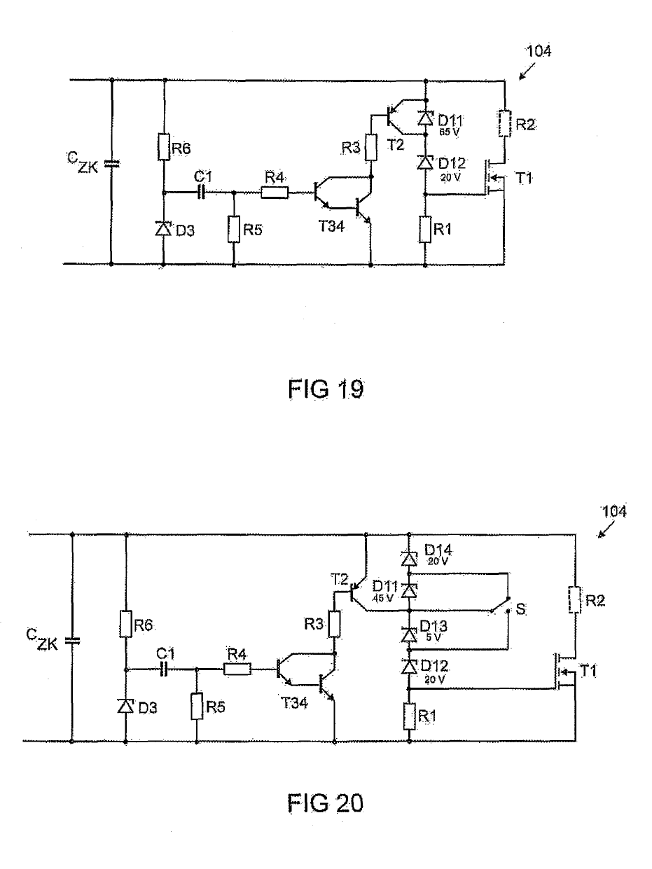

The circuit arrangement shown in FIG. 19 simulates not only the burning voltage of the gas discharge lamp during nominal operation but also the burning voltage profile of a cold gas discharge lamp while it is starting up. For this purpose, a capacitor C1 is charged slowly by a voltage source which is formed from the resistor R6 and the diode D3. Because of the voltage change during the charging process, a current flows via a resistor network formed from R4 and R5 into the transistor T34, which is then switched on, and likewise switches on the transistor T2 via a resistor R3. This results in the zener diode D11 having no effect. The voltage at the drain of the MOSFET T1 (drain-source voltage) is therefore approximately the zener voltage of the diode D12, ignoring the threshold voltage of the MOSFET. The intermediate circuit voltage at this time is therefore always regulated at the zener voltage of the diode D12. This voltage is intended to simulate the lamp voltage of a cold gas discharge lamp shortly after the arc is struck. The greater the extent to which the capacitor C1 is charged, the less becomes the current flowing into the base connection of the transistor T2, as a consequence of which the transistor T2 is switched off to an ever greater extent. The voltage at the drain of the MOSFET T1 therefore rises, thus allowing the intermediate circuit voltage to rise in a corresponding manner. Once the capacitor C1 has been charged completely, current no longer flows, and the transistors T34 and T2 are switched off. At this time, the voltage at the drain of the MOSFET T1 corresponds approximately to the added voltage of the two zener diodes D11 and D12. The intermediate circuit voltage therefore starts at a voltage which corresponds approximately to the zener voltage of the diode D12, then rises slowly over a predetermined time period and ends at the voltage value which corresponds approximately to the added voltage of the two zener diodes D11 and D12. This voltage can be set such that it corresponds to the nominal burning voltage of the gas discharge lamp to be simulated.

The circuit arrangement shown in FIG. 20 is a variant of the circuit arrangement shown in FIG. 19. Only the differences from the circuit arrangement shown in FIG. 19 will therefore be described. The circuit arrangement shown in FIG. 20 offers both of the advantages of the circuit arrangements shown in FIGS. 18 and 19. The circuit arrangement is switchable, in order to make it possible to simulate a discharge lamp without mercury and a discharge lamp which contains mercury. In addition, in the manner described above, the circuit simulates the starting-up of a cold gas discharge lamp. For this purpose, the circuit arrangement shown in FIG. 19 is equipped with a changeover switch S as shown in FIG. 18, and four zener diodes are provided in series between the intermediate circuit voltage and the gate of the transistor T1. The changeover switch shorts out one of four zener diodes in order to generate the corresponding voltage values. In this case, account is taken at the same time of the different cold-starting behavior of gas discharge lamps which contain mercury and those without mercury. The gas discharge lamp which contains mercury (“D1-lamp”) has a minimum cold starting voltage of about 20 V, which then rises to a burning voltage of 85V. The gas discharge lamp without mercury (“D3-lamp”) has a minimum cold starting voltage of 25 V, which then rises to 45V. In order to take account of this, the lowest diode D12 has a zener voltage value of 20 V, the diode D13 above this has a value of 5 V, the following diode D11 has a value of 45 V, and the top diode D14 has a value of 20 V. The threshold voltage of the transistor T1 has been ignored in this analysis.

In order to simulate a gas discharge lamp which contains mercury, the changeover switch S is set such that it bridges the diode D13. The cold starting voltage is therefore 20 V, and the transistor bridges the two diodes D11 and D14, which together produce 65 V. The nominal burning voltage in the steady state is therefore set to 85 V.

In order to simulate the gas discharge lamp without mercury, the changeover switch S is set such that it bridges the diode D11. The cold starting voltage is therefore the sum of the two zener voltages of the diodes D12 and D13, in this case 25 V, and the transistor bridges the diode D14, which operates at 20 V. The diode D11 is bridged by the switch S, and therefore has no effect. The nominal burning voltage in the steady state is therefore set to 45 V.

### LIST OF REFERENCE SYMBOLS

1 Reference ring
10 Cap
100 Operating electronics
101 Dissipative overvoltage protection
102 EMC filter
103 Full-wave rectifier
104 Voltage intermediate circuit
105 Step-down DC voltage converter
11 Reference plane
13 Reference lugs/studs
15 Reference lug/cap housing
17 Inner cap
21 Multichip light-emitting diode (arranged on both sides)
22 Optics for multichip light-emitting diode
23 Multichip light-emitting diode (arranged on only one side)
25 Light-emitting diode chips
3 Supporting structure
31 Recess (on one side)
33 Recess (on both sides)
34 Cooling structure
341 First heat sink in the form of a cap housing
342 Second heat sink in the form of a cap housing
343 Thermal isolation layer
35 Web
36 First part of the supporting structure 3
37 Third part of the supporting structure 3
39 Second part of the supporting structure 3
391 First functional unit of the second part 39 of the supporting structure 3
392 Second functional unit of the second part 39 of the supporting structure 3
393 First face of the second part 39 of the supporting structure 3
394 Second face of the second part 39 of the supporting structure 3
5 Headlamp
6 Protective bulb
7 Cap sleeve
71 Cap block/connecting socket
73 Contact tabs/contacts
75 Operating electronics in the cap
76 Operating electronics on the supporting structure
80 Thermal and electrical contact area
82 Adhesive point

1. A headlamp having a cap and a light output which is predetermined by international standardization with respect to the distance and position with respect to a reference plane of the cap, wherein the light output is provided by one or more semiconductor light sources.

2. The headlamp as claimed in claim 1, wherein operating electronics or a part of the operating electronics for operation of the one or more semiconductor light sources are or is arranged in the cap of the headlamp.

3. The headlamp as claimed in claim 2, wherein the one or more semiconductor light sources is or are arranged on a supporting structure having a first flat face and a second flat face parallel thereto.

4. The headlamp as claimed in claim 3, wherein in each case at least one semiconductor light source is located on the first flat face, and at least one semiconductor light source is located on the second flat face, coincident with respect to one another, and, in the area of the semiconductor light sources which are located one above the other coincidentally, the supporting structure has a web between the first and the second flat faces, which web has a thickness of such a size that the light-emitting surfaces of the semiconductor light sources are at a distance from one another which corresponds to an average diameter, as stipulated in the standard, of the at least one of the discharge arc described there and of the incandescent filament described there.

5. The headlamp as claimed in claim 3, wherein one or more semiconductor light sources is or are in each case arranged on both flat faces of the supporting structure, wherein in each case at least one semiconductor light source is positioned on the first flat face, and at least one semiconductor light source is positioned on the second flat face, alternately, or at least partially coincidentally opposite.

6. The headlamp as claimed in claim 2,
wherein the supporting structure is at the same time in the form of a heat sink and is composed of a highly thermally conductive material, wherein the supporting structure comprises at least one first part and one second part, the first part of the supporting structure is at the same time in the form of a heat sink, and the second part of the supporting structure is in the form of a support for the semiconductor light sources and is composed of a highly thermally conductive material.

7. The headlamp as claimed in claim 6, wherein the supporting structure comprises more than two parts, wherein some of the parts are composed of an electrically conductive material and are at the same time in the form of power supply lines, wherein the second part of the supporting structure may partially or completely have the operating electronics.

8. The headlamp as claimed in claim 2, wherein the supporting structure tapers toward the tip of the lamp.

9. The headlamp as claimed in claim 2, wherein the operating electronics are thermally connected to a first heat sink, which is in the form of a first part of the cap housing, and the supporting structure is thermally connected to a second heat sink, which is in the form of a second part of the cap housing, wherein the first heat sink and the second heat sink are thermally isolated from one another.

10. The headlamp as claimed in claim 1,
wherein the semiconductor light sources have optics which vary a light emission characteristic of the semiconductor light sources such that this corresponds to an emission characteristic as required in the Standard.

11. The headlamp as claimed in claim 1,
wherein the semiconductor light sources are selected from a group consisting of: a light-emitting diode; a multichip light-emitting diode; and an organic light-emitting diode.

12. The headlamp as claimed in claim 1,
wherein the semiconductor light sources are coated with a protective layer.

13. The headlamp as claimed in claim 2, wherein the supporting structure together with the semiconductor light sources is surrounded by a protective bulb, wherein the material of the protective bulb is a light-transmissive plastic or a glass, and the protective bulb is filled with a gas.

14. A use of a headlamp as a replacement for a headlamp in the form of an incandescent lamp or a gas discharge lamp, in a headlight which is intended to hold the incandescent lamp or gas discharge lamp, the headlamp comprising:
a cap and a light output which is predetermined by international standardization with respect to the distance and position with respect to a reference plane of the cap, wherein the light output is provided by one or more semiconductor light sources.

15. The headlamp as claimed in claim 2,
wherein the supporting structure has a cooling structure which protrudes sideways.

16. The headlamp as claimed in claim 2,
wherein the supporting structure has at least one of a heat-emitting and antireflective coating.
